(19) United States
(12) Patent Application Publication
(10) Pub. No.: US 2006/0028211 A1
(43) Pub. Date: Feb. 9, 2006

(54) Pointer type automatic tester with storage battery

(76) Inventor: Jun Liu, Nanjing (CN)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/194,415

(22) Filed: Aug. 1, 2005

(30) Foreign Application Priority Data
Aug. 9, 2004 (CN) 200420078455.7

(51) Int. Cl. G01N 27/416

(52) U.S. Cl. 324/426

(57) ABSTRACT

The present invention provides an improved way of testing. Named a pointer type automatic tester with storage battery, this apparatus is to replace the hand-operated tester. It is designed to discard the inaccuracy of a test caused by handwork operation due to the different ways of pressing the button and therefore different resistance. With the application of this utility model, the totally programmed test will rule out the manual factors that affect the accuracy of a test. This model is low in cost, practicable, simple, and easy to operate. It contains a start key that is to connect with singlechip. The singlechip is to connect with amplifying circuit and a buzzer. An amplifying circuit is to connect with a relay. The relay has two contacts, one for the connection of negative pole and the other for load resistance. The relay also links with positive pole as well as an optocoupler. And a TVS tube or surge absorber is installed between an optocoupler and a load resistance

### BACKGROUND OF THE INVENTION

This invention relates to a automatic detecting and control device and in particular to a accumulator used automatic detecting device.

Heretobefore, the testers have long been widely operated by handwork. The manual type of operations renders the result of a test inaccurate due to the various contact resistances caused by a particular person's hard or light press on the button. In addition, an accurate testing should be conducted in a fixed period of time while manual operation could not be well controlled. With manual operation, a conductor has to pay attention to press the button while observe and read the meter.

### SUMMARY OF THE INVENTION

Considered broadly, pointer type automatic testers according to the invention are designed to solve the above mentioned problems make the result of each particular test accurate. The invention comprises a meter and a stabilized voltage supply. The main characteristics that a singlechip is installed between a start key and amplifying circuit. And an amplifying circuit goes between a singlechip and a relay. The open contact of a relay links with load resistance and the close connect links with negative pole. The load resistance also links up with positive pole.

The merit of the present invention is that the test is to be conducted automatically, which rules out disturbance from the manual operations. Testing time is controlled within 10 seconds, usually 8 seconds. A conductor, under such a circumstances, has no point in observing the testing time; he or she may just concentrate on observing and reading meter. Is this way, the accuracy is improved substantially. The present invention is low in cost, simple, practicable, and easy to operate.

### BRIEF DESCRIPTION OF THE DRAWINGS

FIG. 1 is schematic diagram illustrating embodiment embodying the inventive concept.

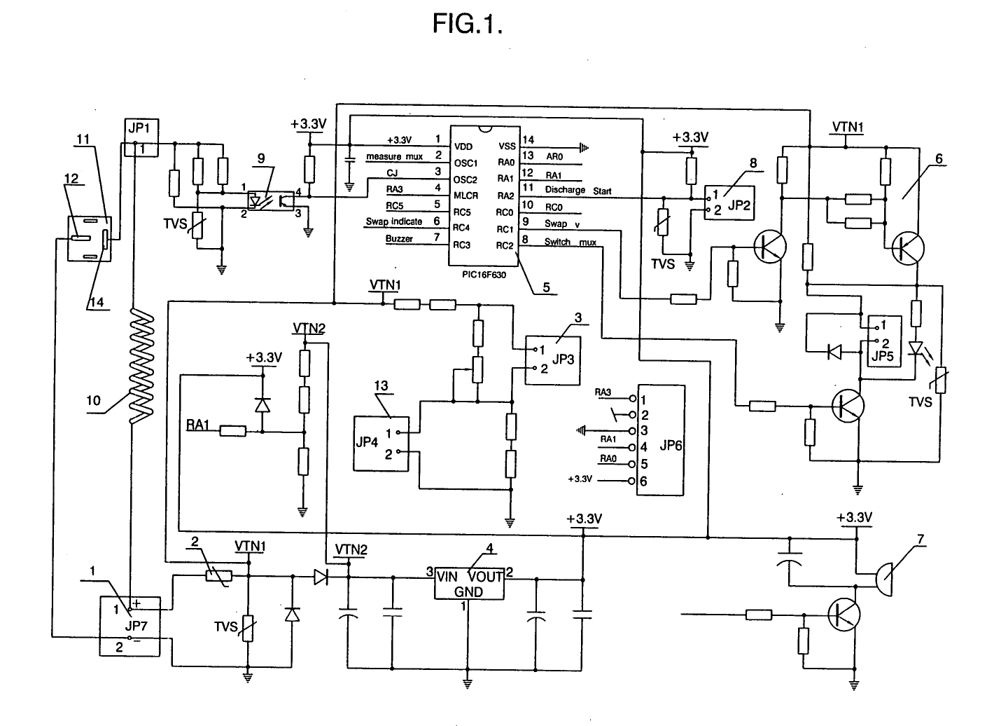

### DESCRIPTION OF THE PREFERRED EMBODIMENTS

In the particularly advantageous embodiment of the invention illustrated, power supply input 1 comprises a positive pole and a negative pole. After the input, one circuit travels, through self-recovery fuse to positive pole and negative pole of meter 3. The indicated number on the dial plate of meter 3 increases as the pressure moves to its maximum 16V. Another circuit travels from power supply input 1, through a diode and optocoupler, to stabilizing chip 4 to provide power supply at 3.3 V. Singlechip 5 is to connect an amplifying circuit 6 and buzzer 7. Also singlechip 5 is to link with a start key 8 and start key 8 connect, through optocoupler 9, to load resistance 10. One of the outlets of load resistance 10 is for the connection of normally open contact 14 and the other for positive pole. Normally open contact 12 of relay is for negative pole. Load resistance 10, normally close contact 12 and normally open contact 14 of relay 11 form a closed circuit. The output of amplifying circuit 6 links to loop of relay 11. Start key 8 conduct to the loop of relay 11. There is a switch key 13 attached to contact, which allows the operator to choose 6V or 12V for testing.

When doing the test, one should begin with inputting the power through positive and negative pole so that the stabilized voltage supply chip 4 can provide electricity to all parts. When you hear the second sound made by buzzer 7, it means the apparatus is in working condition. The times and loudness is controlled by singlechip 5. When pressing start key 8, singlechip 5 will order buzzer 7 to make one more sound, which means the set program begins. Start key 8 will connect, through optocoupler 9, with load resistance 10 while optocoupler 9 functions as signal separation. A TVS tube must be installed to function as a surge absorber in order to protect the circuit. Singlechip 5 controls the dynatron in amplifying circuit 6 and electricity go through the loop of relay 11 at 6V. When normally open contact 12 and close contact 14 are connected, the circuit is closed. Load resistance 10 and meter are parallel circuit. When the switch of storage battery is on, the heavy current will go through resistance 10. LED is connected in parallel with relay 11 to demonstrate the attracting time of relay. The attracting time is within 10 seconds; we do 8 seconds in the illustration, which is preset by singlechip 5 in the circuit. After 8 seconds, singlechip 5 will order buzzer 7 sound twice so a conductor knows that the test is completed.

After 6V test, you may want to conduct a 12V test, then you switch directly to 12V by pressing the switch key 13.

To facilitate the test, the scale plate is divided into three areas, of which red shows that the storage battery is damaged, yellow demonstrates that the battery needs to be recharged and green indicate that it is in working condition.

The model of Singlechip 5 is PIC16F630 and stabilized voltage supply chip is LM1117IDTX—3.3.

The model of TVS tube (surge absorber) installed between optocoupler 9 and load resistance 10 is HL0805ML180C. The model of surge absorber attached to start key 8 is HL0603-050E220NP. The model of surge absorber attached to input 1 and LED of relay 11 is HL1812ML180C. All the TVS tube or surge absorber is installed to protect the circuit.

The foregoing description is to be considered merely as illustrative of the invention and not in limitation thereof.

1. A pointer type automatic tester with storage battery comprising: meter, stabilized voltage supply; wherein the start key links to singlechip and singlechip links to amplifying circuit connected with relay, of which its normally open contact is to link up with load resistance which is also connected with positive pole, while the close contact of relay is to connect negative pole of the power.

2. A pointer type automatic tester with storage battery according to claim 1 wherein said load resistance is connected with the opt coupler.

3. A pointer type automatic tester with storage battery according to claim 1 wherein said meter circuit means comprises a 6V and 12V switch key.

4. A pointer type automatic tester with storage battery according to claim 1 wherein said output of stabilized voltage supply is connected with buzzer.

5. A pointer type automatic tester with storage battery according to claim 2 wherein a TVS tube is installed between opt coupler and load resistance.

6. A pointer type automatic tester with storage battery according to claim 1 wherein a TVS tube is installed between start key and singlechip.

7. A pointer type automatic tester with storage battery according to claim 1 wherein a TVS tube is installed between amplifying circuit and relay.

8. A pointer type automatic tester with storage battery according to claim 1 wherein a TVS tube is attached to the input of power.
